(19) United States
(12) Patent Application Publication
(10) Pub. No.: US 2021/0223728 A1
(43) Pub. Date: Jul. 22, 2021

(54) HEATER AND FIXING APPARATUS

(71) Applicant: CANON KABUSHIKI KAISHA, Tokyo (JP)

(72) Inventors: Kazushi Nishikata, Tokyo (JP); Ryota Ogura, Numazu-shi (JP); Takafumi Suzuki, Suntou-gun (JP); Seiji Obata, Mishima-shi (JP); Koichi Yamada, Mishima-shi (JP)

(21) Appl. No.: 17/223,926

(22) Filed: Apr. 6, 2021

Related U.S. Application Data
(63) Continuation of application No. 16/414,586, filed on May 16, 2019, now Pat. No. 10,996,598.

(30) Foreign Application Priority Data
May 30, 2018 (JP) 2018-103911

(51) Int. Cl. G03G 15/20

(52) U.S. Cl. CPC G03G 15/2039; G03G 15/2053

(57) ABSTRACT

At least an electrode of a first electrode group and at least an electrode of a second electrode group are formed in a region nearer to one edge portion of a substrate than to a center of the substrate in a longer-side direction of the substrate, and the electrode that is nearest to the second electrode group in the longer-side direction among the first electrode group formed in the region nearer to the one edge portion and the second electrode group are provided with a space between the electrode and the second electrode group.

### CROSS-REFERENCE TO RELATED APPLICATIONS

The present application is a continuation of U.S. patent application Ser. No. 16/414586, filed on May 16, 2019, which claims priority from Japanese Patent Application No. 2018-103911 filed May 30, 2018, which are hereby incorporated by reference herein in their entireties.

### BACKGROUND OF THE INVENTION

### Field of the Invention

The present invention relates to a fixing apparatus mounted on an image forming apparatus using an electrophotographic recording method, such as a copying machine or printer, and a heater mounted on the fixing apparatus.

### Description of the Related Art

Japanese Patent Application Laid-Open No. 2017-054071 discusses a fixing apparatus in which a heater including a plurality of independently-controllable heat generation blocks is provided in an inner space of a cylindrical fixing film. The heater is provided with a thermistor for each heat generation block. An electrode for feeding power to the heat generation block is provided to a surface of a heater substrate, and an electrode for the thermistor is provided to another surface of the heater substrate.

Basic insulation, or reinforced insulation in some cases, is needed between the electrode for the heat generation block and the electrode for the thermistor. In a case where the two electrodes are provided at the same position on the front and rear surfaces of the substrate, an insulation distance is required in both longer-side and shorter-side directions of the heater. However, if the width in the shorter-side direction of the heater is increased in order to preserve the insulation distance, the heat capacity of the heater increases, and the start-up time of the heater becomes longer. If an excess space portion is provided in the shorter-side direction of the heater, the heater becomes less resistant to thermal stress. Furthermore, wiring connected to each electrode via an electric connector is also required to preserve the insulation distance from the other electrode. Thus, in order to form the wiring while preserving the insulation distance, an excess space is needed. Especially in a division heater as discussed in Japanese Patent Application Laid-Open No. 2017-054071, the number of electrodes for heat generation members and electrodes for thermistors is significantly large. This makes it difficult to prevent congestion of the electric connectors and the wiring to the electrodes near an edge portion in the longer-side direction of the heater, and thus the apparatus size often increases.

### SUMMARY OF THE INVENTION

The present invention is directed to a heater capable of ensuring insulation between an electrode for a heat generation block (heat generation member) and an electrode for a thermistor (temperature detection element), and a fixing apparatus including the heater.

According to an aspect of the present invention, a heater for use in a fixing apparatus configured to fix an unfixed toner image formed on a recording material to the recording material includes a substrate, a plurality of heat generation members which is formed on a first surface of the substrate and is controllable independently of each other, a first electrode group which is formed on the first surface and with which a plurality of first power feeding terminals configured to feed power to the plurality of heat generation members and provided to the fixing apparatus is in contact, a plurality of temperature detection elements formed on a second surface of the substrate which is on an opposite side to the first surface, and a second electrode group which is formed on the second surface and with which a plurality of second power feeding terminals configured to feed power to the plurality of temperature detection elements and provided to the fixing apparatus is in contact, wherein at least an electrode of the first electrode group and at least an electrode of the second electrode group are formed in a region nearer to one edge portion of the substrate than to a center of the substrate in a longer-side direction of the substrate, and wherein the electrode that is nearest to the second electrode group in the longer-side direction among the first electrode group formed in the region nearer to the one edge portion and the second electrode group are provided with a space between the electrode and the second electrode group.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming apparatus.

FIG. 2 is a cross-sectional view illustrating a fixing apparatus.

FIGS. 3A and 3B are cross-sectional views illustrating an edge portion of the fixing apparatus according to a first exemplary embodiment.

FIG. 4 is a cross-sectional view illustrating a heater.

FIGS. 5A, 5B, 5C, and 5D illustrate the heater according to the first exemplary embodiment.

FIGS. 6A, 6B, and 6C are top views illustrating an edge portion of a fixing apparatus according to the first exemplary embodiment.

FIGS. 7A, 7B, 7C, and 7D illustrate the heater according to a second exemplary embodiment.

FIGS. 8A and 8B are cross-sectional views illustrating an edge portion of the fixing apparatus according to the second exemplary embodiment.

FIGS. 9A and 9B are top views illustrating the edge portion of the fixing apparatus according to the second exemplary embodiment.

FIG. 10 illustrates another structure according to the second exemplary embodiment.

FIG. 11 is a cross-sectional view illustrating the heater according to a third exemplary embodiment.

FIGS. 12A, 12B, 12C, and 12D illustrate the heater according to the third exemplary embodiment.

FIGS. 13A and 13B are cross-sectional views illustrating the edge portion of the fixing apparatus according to the third exemplary embodiment.

FIGS. 14A and 14B are top views illustrating the edge portion of the fixing apparatus according to the third exemplary embodiment.

### DESCRIPTION OF THE EMBODIMENTS

### (Image Forming Apparatus)

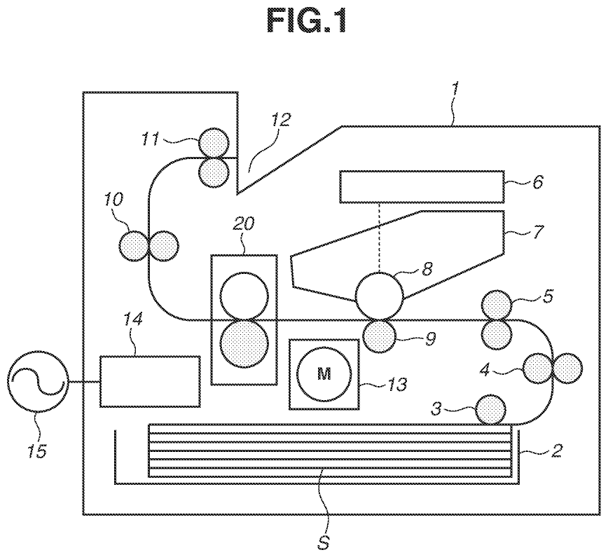

A first exemplary embodiment will be described below. FIG. 1 is a cross-sectional view illustrating an image forming apparatus (hereinafter, “laser beam printer”) 1 using an electrophotographic technology. If a print signal is generated, a scanner unit 6 emits laser light modulated based on image information, and a photosensitive member 8 contained in an image forming processing unit 7 is scanned. An electrostatic latent image based on the laser light is formed on the photosensitive member 8, and if toner is supplied, a toner image based on the image information is formed on the photosensitive member 8. Meanwhile, a recording material S such as a normal sheet stacked on a sheet feeding cassette 2 is fed one by one by a pickup roller 3 and conveyed by a sheet conveyance roller 4 and a registration roller 5 toward an area between the photosensitive member 8 and a transfer roller 9. While the recording material S passes through the area between the photosensitive member 8 and the transfer roller 9, the toner image formed on the photosensitive member 8 is transferred onto the recording material S. Thereafter, the recording material S is heated by a fixing device 20, so that the toner image is heated and fixed to the recording material S. The recording material S carrying the fixed toner image is discharged onto a sheet discharge tray 12 provided to an upper portion of the laser printer 1 by a sheet conveyance roller 10 and a sheet discharge roller 11. A motor 13 drives the fixing device 20. A control circuit 14 is connected to a commercial power source 15 and supplies power to the fixing device 20 and the other loads.

### (Fixing Device)

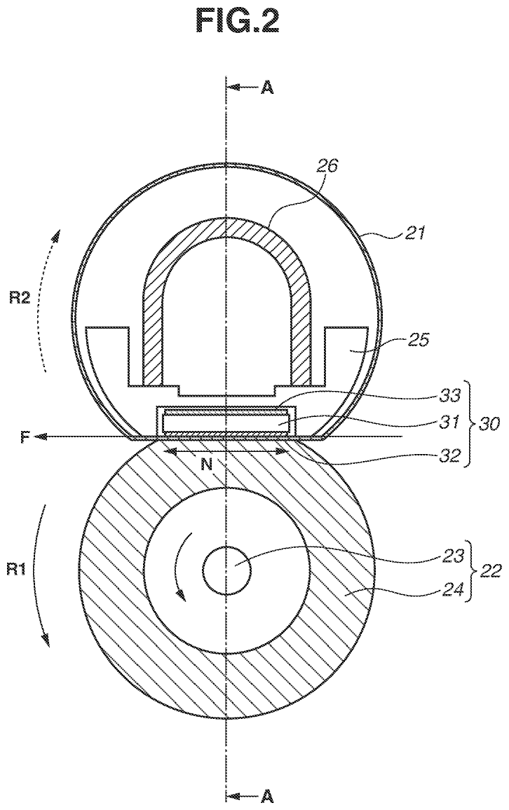

FIG. 2 is a cross-sectional view illustrating the fixing device 20. The fixing device 20 includes a cylindrical film (fixing film) 21, a heater 30, and a pressing roller (nip area forming member) 22. The heater 30 is in contact with an inner surface of the film 21. The pressing roller 22 forms a fixing nip area N together with the heater 30 via the film 21. The film 21 is in contact with an unfixed toner image formed on the recording material S. The pressing roller 22 includes a core metal 23 made of a material such as iron or aluminum and an elastic layer 24 made of a material such as heat-resistant rubber. The heater 30 is held by a heater holder 25 which is a holding member made of a heat-resistant resin. The heater holder 25 also has a guide function of guiding a rotation of the film 21. A metallic stay 26 is provided to apply the pressure of a spring (not illustrated) to the heater holder 25.

The stay 26 receives the pressure of the spring (not illustrated) and biases the heater 30 via the heater holder 25 toward the pressing roller 22. The elastic layer 24 of the pressing roller 22 receives the biasing force and is elastically deformed, and the fixing nip area N is formed. The film 21 is pinched at the fixing nip area N by the heater 30 and the pressing roller 22. If the pressing roller 22 is rotated in the direction of an arrow R1 by the motor 13 via a gear train (not illustrated), the film 21 pinched at the fixing nip area N is rotated in the direction of an arrow R2. An arrow F indicates a sheet conveyance direction of the recording material S. The recording material S carrying an unfixed toner image is conveyed into the fixing nip area N formed by the rotating pressing roller 22 and the rotated film 21 and undergoes heating and fixing processing (the unfixed toner image is fixed to the recording material S with heat of the heater 30) while being pinched and conveyed. A structure of the heater 30 will be described below.

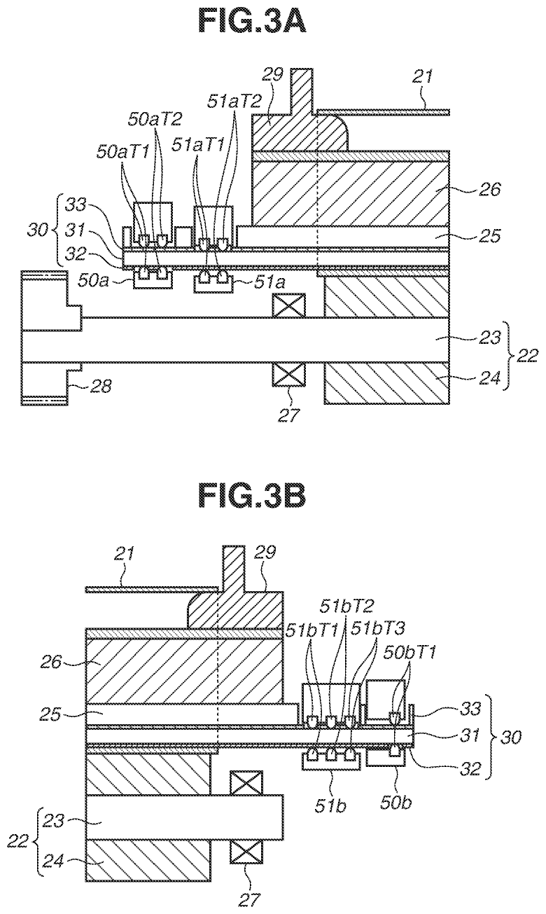

FIGS. 3A and 3B are cross-sectional views along a line A-A specified in FIG. 2 and illustrate a structure of an edge portion in a longer-side direction of the fixing device 20 according to the first exemplary embodiment. FIG. 3A illustrates a structure of a driving-side edge portion, and FIG. 3B illustrates a structure of a non-driving-side edge portion. A bearing 27 of the pressing roller 22 rotatably supports the pressing roller 22. An input gear 28 is attached to the pressing roller 22. A flange 29 is provided at a position facing both edge portions of the film 21 and guides a rotation locus of the film 21. Connectors 50a, 50b, 51a, and 51b are electric contact members connected to the heater 30. Details of the connectors 50a, 50b, 51a, and 51b will be described below.

### (Heater)

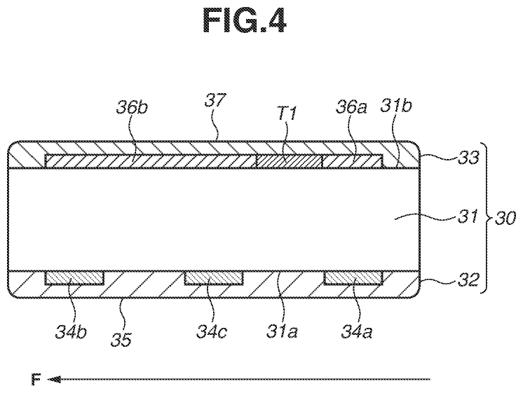

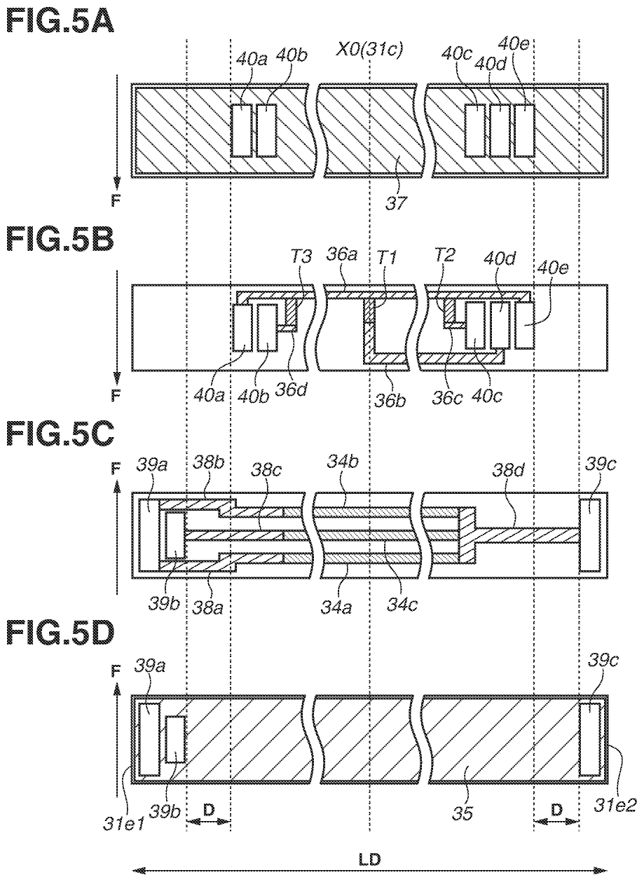

Next, a structure of the heater 30 according to the first exemplary embodiment will be described. FIG. 4 is a cross-sectional view illustrating a center of the heater 30 in the longer-side direction and corresponds to an enlarged view of the heater 30 illustrated in FIG. 2. FIGS. 5A, 5B, 5C, and 5D are plan views illustrating a structure of the heater 30 in a longer-side direction LD. FIGS. 5A and 5B illustrate the structure viewed from a rear surface layer 33. FIG. 5A is a top view with a protection glass 37, and FIG. 5B is a top view without the protection glass 37. FIGS. 5C and 5D illustrate the structure viewed from a sliding surface layer 32. FIG. 5D is a top view with a protection glass 35, and FIG. 5C is a top view without the protection glass 35. An arrow F specifies the sheet conveyance direction of the recording material S. Further, a reference X0 in FIGS. 5A to 5D is a recording material conveyance reference position and matches a center of the recording material S in a width direction of the recording material S. In a case of feeding the recording materials S of different sizes, the recording materials S are conveyed with the center of each recording material S in the width direction registered to the reference X0. In the case of the present exemplary embodiment, the reference X0 is a center 31c of a substrate 31 in the longer-side direction LD of the substrate 31.

The heater 30 in the present exemplary embodiment includes the substrate 31 and a plurality of heat generation members 34a to 34c which is formed on a first surface 31a of the substrate 31 and is controllable independently of each other. The heater 30 further includes a first electrode group including first electrodes 39a to 39c formed on the first surface 31a, and a plurality of power feeding terminals (first power feeding terminals) 50aT1, 50aT2, and 50bT1 for feeding power to the plurality of heat generation members 34a to 34c is in contact with the first electrodes 39a to 39c. The heater 30 further includes a plurality of temperature detection elements T1 to T3 formed on a second surface 31b of the substrate 31 which is on the opposite side to the first surface 31a. The heater 30 further includes a second electrode group including second electrodes 40a to 40e formed on the second surface 31b, and a plurality of power feeding terminals (second power feeding terminals) 51aT1, 51aT2, 51bT1, 51bT2, and 51bT3 for feeding power to the plurality of temperature detection elements T1 to T3 is in contact with the second electrodes 40a to 40e.

At least the first electrodes 39a and 39b of the first electrodes 39a to 39c and at least the second electrodes 40a and 40b of the second electrodes 40a to 40e are formed nearer to an edge portion (first edge portion) 31e1 than to the center 31c of the substrate 31 in the longer-side direction LD of the substrate 31. The electrode 39b which is nearest to the second electrodes 40a and 40b in the longer-side direction LD among the first electrodes 39a and 39b formed in the region nearer to the edge portion 31e1 and the second electrodes 40a and 40b are provided with a space of a distance D between the electrode 39b and the second electrodes 40a and 40b. The second electrodes 40a to 40e are provided nearer to the center 31c of the substrate 31 than the first electrodes 39a to 39c in the longer-side direction LD. Details thereof will be described below. An edge portion 31e2 (second edge portion) is another edge portion of the substrate 31.

The surface of the substrate 31 that is on the sliding surface layer 32 side is provided with the heat generation members 34a to 34c extending in the longer-side direction of the heater 30. The heat generation members 34a and 34b are respectively provided upstream and downstream in the sheet conveyance direction of the recording material S, and the heat generation member 34c is provided at a center. The insulative protection glass 35 is provided so as to cover an upper portion of the three heat generation members 34a to 34c. The film 21 is slid on a front surface of the protection glass 35. The rear surface layer 33 of the substrate 31 is provided with the printed thermistor (temperature detection element) T1 and conductors 36a and 36b for passing current to the thermistor T1. The thermistor T1 has a negative resistance temperature characteristic, has a characteristic that a resistance value changes depending on temperature, and has a function of detecting the temperature of the heater 30. The protection glass 37 is provided so as to cover the thermistor T1 and the conductors 36a and 36b.

As illustrated in FIG. 5C, the heat generation members 34a to 34c extend along the longer-side direction LD of the heater 30 on the sliding surface layer 32, and conductors 38a to 38d and the electrodes 39a to 39c for heat generation members are connected to edge portions of the three heat generation members 34a to 34c. The conductor 38d and the electrode 39c for heat generation members are a common conductive member and a common electrode connected to one edge of each of the three heat generation members 34a to 34c. The other edge of the heat generation member 34a is connected to the electrode 39a for heat generation members via the conductor 38a. Similarly, the other edge of the heat generation member 34b is connected to the electrode 39a for heat generation members via the conductor 38b. Similarly, the other edge of the heat generation member 34c is connected to the electrode 39b for heat generation members via the conductor 38c. Thus, the heater circuit is configured in such a manner that if power is fed between the electrodes 39a and 39c for heat generation members, the heat generation members 34a and 34b simultaneously generate heat, and if power is fed between the electrodes 39b and 39c, the heat generation member 34c generates heat. The protection glass 35 is provided at an upper portion of the sliding surface layer 32 so as to cover the components other than the electrodes 39a to 39c for heat generation members. Specifically, as illustrated in FIG. 5D, only the electrodes 39a to 39c for heat generation members are exposed. The power feeding terminals 50aT1, 50aT2, and 50bT1 of the electric contact members described below are in contact with the electrodes 39a to 39c for heat generation members, so that a power feeding circuit for feeding power from the commercial power source 15 to the heat generation members 34a to 34c is formed. In the heater 30 according to the present exemplary embodiment, two electrodes, the electrodes 39a and 39b for heat generation members, form an electrode group for heat generation members at the left edge portion in FIG. 5D, and one electrode, electrode 39c for heat generation member, is provided at the right edge portion in FIG. 5D.

Next, a structure of the rear surface layer 33 will be described with reference to FIG. 5B. The printed thermistors T1, T2, and T3 are formed on the second surface 31b. The conductors 36a to 36d and the electrodes 40a to 40e are connected to the thermistors T1, T2, and T3. The thermistors T1, T2, and T3 are connected to the control circuit 14 via the electric contact members and the conductive members described below. The control circuit 14 detects a temperature by measuring the resistance value of each of the thermistors T1, T2, and T3. The thermistor T1 is provided at a position that substantially corresponds to the sheet conveyance reference position X0. The control circuit 14 controls power to be fed to each heat generation member so as to maintain the detection temperature of the thermistor T1 at a target temperature suitable for fixing.

The thermistors T2 and T3 are formed near the edge portions of the heat generation members 34a to 34c in the longer-side direction LD. The thermistors T2 and T3 are provided to detect the temperature of a portion of the heater 30 by which no sheet passes in a case where small-size recording materials S consecutively passes. The conductor 36a is connected to one edge of each of thermistors T1, T2, and T3 and is also connected to the electrodes 40a and 40e provided at respective edges. The electrodes 40a and 40e are connected to a ground potential of the control circuit 14 via the electric contact members and the conductive members described below. Edges of the conductors 36b to 36d are respectively connected to thermistors T1 to T3, and the other edges of the conductors 36b to 36d are respectively connected to the electrodes 40d, 40c, and 40b. The protection glass 37 covers the component other than the electrodes 40a to 40e. Specifically, as illustrated in FIG. 5A, only the electrodes 40a to 40e are exposed at the rear surface layer 33, and the electric contact members described below are in contact with the electrodes 40a to 40e. In this way, the control circuit 14 detects the temperature of each of the thermistors T1, T2, and T3. In the present exemplary embodiment, the electrodes 40a and 40b for thermistors form part of the second electrode group, and the electrodes 40c to 40e for thermistors also form the second electrode group.

In the heater 30 according to the present exemplary embodiment, the electrode 39b, which is the nearest one of the electrodes 39a and 39b for heat generation members to the electrodes 40a and 40b for thermistors, and the electrode 40a, which is the nearest one of the electrodes 40a and 40b for thermistors to the electrodes 39a and 39b for heat generation members, are provided at the distance D from each other in the longer-side direction LD of the heater 30. The distance D is preserved to preserve a required insulation distance between the electrodes 39a to 39c for heat generation members and the electrodes 40a to 40e for thermistors. The distance D is preserved, so that the width of the substrate 31 of the heater 30 in the shorter-side direction does not have to be increased to preserve the insulation distance. In this way, the heater 30 is realized in which the insulation distance is preserved between the two electrodes while the heater 30 has excellent temperature-rise characteristics and is resistant to thermal stress applied to the substrate 31. The distance D is also preserved between the electrode 39c for heat generation members and the electrode 40e for thermistors which are provided between the center 31c and the edge portion 31e2.

### (Structure of Electric Contact Member and Conductive Member)

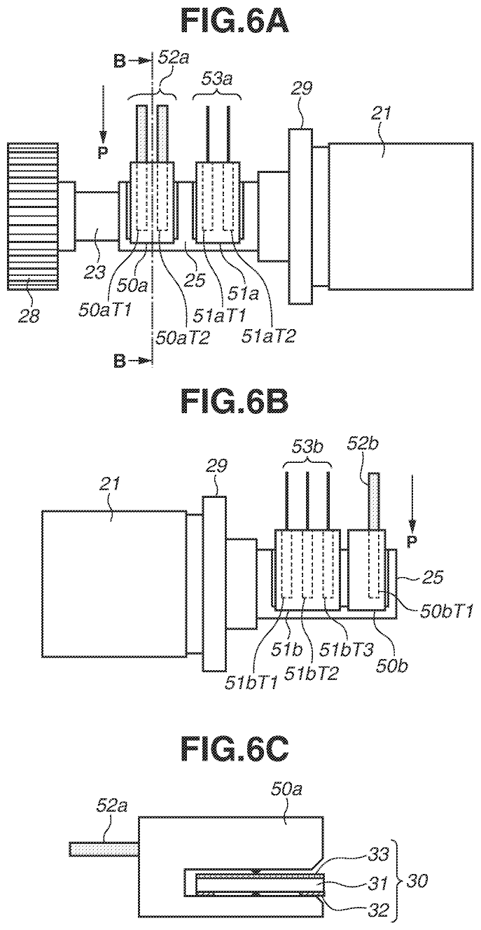

Next, a structure of the electric contact members and the conductive members which are connected to the electrodes 39a to 39c for heat generation members and the electrodes 40a to 40e for thermistors and ensure energization to the control circuit 14 will be described with reference to FIGS. 3A, 3B, 6A, 6B, and 6C.

FIGS. 6A, 6B, and 6C are top views of FIGS. 3A and 3B. FIG. 6A illustrates a structure of the driving-side of the fixing device 20, and FIG. 6B illustrates a structure of the non-driving-side of the fixing device 20. The connectors 50a and 50b (electric contact members) for heat generation members are in contact with the electrodes 39a to 39c for heat generation members. The connector 50a is provided with the power feeding terminals 50aT1 and 50aT2. The power feeding terminal 50aT1 is in contact with the electrode 39a for heat generation members. The power feeding terminal 50aT2 is in contact with the electrode 39b for heat generation member. The connector 50b is provided with the power feeding terminal 50bT1. The power feeding terminal 50bT1 is in contact with the electrode 39c for heat generation members. The power feeding terminals 50aT1, 50aT2, and 50bT1 correspond to a plurality of first power feeding terminals provided to the fixing apparatus.

FIG. 6C is a cross-sectional view along a line B-B specified in FIG. 6A and illustrates a structure of the connector 50a for heat generation members. As illustrated in FIG. 6C, the connector 50a is a substantially U-shaped plug-in connector and is inserted in the direction of an arrow P into the electrodes 39a and 39b for heat generation members, so that the terminals 50aT1 and 50aT2 in the connector 50a are electrically connected to the electrodes 39a and 39b on the heater 30. The connector 50b has a similar structure and is connected to the electrode 39c for heat generation members. Conductive members (cables for heat generation member) 52a and 52b extend from the connectors 50a and 50b and are connected to the control circuit 14 through a path (not illustrated).

The connectors (electric contact member) 51a and 51b for thermistors are provided nearer to the center in the longer-side direction LD than the positions on the heater 30 to which the connectors 50a and 50b for heat generation members are connected. The connectors 51a and 51b are to be connected to the electrodes 40a to 40e for thermistors. Specifically, the second electrodes 40a to 40e are provided nearer to the center of the substrate 31 in the longer-side direction LD of the substrate 31 than the first electrodes 39a to 39c. The connectors 51a and 51b for thermistors are substantially U-shaped plug-in connectors similar to the connectors 50a and 50b for heat generation members and are to be connected to the electrodes 40a to 40e formed in the rear surface layer 33. The connector 51a is provided with the power feeding terminals 51aT1 and 51aT2. The power feeding terminal 51aT1 is in contact with the electrode 40a. The power feeding terminal 51aT2 is in contact with the electrode 40b. The connector 51b is provided with the power feeding terminals 51bT1, 51bT2, and 51bT3. The power feeding terminal 51bT1 is in contact with the electrode 40c. The power feeding terminal 51bT2 is in contact with the electrode 40d. The power feeding terminal 51bT3 is in contact with the electrode 40e. Conductive members (cables for thermistors) 53a and 53b extend from the connectors 51a and 51b for thermistors and are connected to the control circuit 14 through a path (not illustrated). The power feeding terminals 51aT1, 51aT2, 51bT1, 51bT2, and 51bT3 correspond to a plurality of second power feeding terminals provided to the fixing apparatus.

A feature of the present exemplary embodiment is that the connectors 51a and 51b for thermistors and the cables 53a and 53b for thermistors are provided along the shorter-side direction of the heater 30. Specifically, the second electrodes 40a to 40e are provided such that the plurality of second power feeding terminals 51aT1, 51aT2, 51bT1, 51bT2, and 51bT3 are connected to the second electrodes 40a to 40e from a direction which intersects with the longer-side direction LD of the substrate 31 and which is parallel to the second surface 31b of the substrate 31. Since the electrodes 39a to 39c for heat generation members are provided near the connectors 51a and 51b for thermistors and the cables 53a and 53b for thermistors, if the connectors 51a and 51b for thermistors and the cables 53a and 53b for thermistors are provided along the longer-side direction LD of the heater 30, it becomes difficult to preserve the insulation distance. Specifically, since the connectors 51a and 51b for thermistors and the cables 53a and 53b for thermistors are provided near and at the back of the electrodes 39a to 39c for heat generation members, so that it becomes difficult to preserve the insulation distance. In order to preserve the insulation distance, the electrodes 39a to 39c for heat generation members need to be provided at a great distance from the electrodes 40a to 40e for thermistors, but this leads to an increase in size of the heater 30 and the fixing device 20. In the structure according to the present exemplary embodiment, the insulation distance is preserved without situating the connectors 51a and 51b for thermistors and the cables 53a and 53b for thermistors at a great distance from the electrodes 39a to 39c for heat generation members, so that the structures of the edge portions of the heater 30 where the electrodes are congested can be a compact structure. While the cables 53a and 53b are wired upward (i.e., toward the upstream side of the sheet conveyance direction P of the recording material S) in FIGS. 6A and 6B in the present exemplary embodiment, the cables 53a and 53b can be wired downward (toward the downstream side of the sheet conveyance direction P).

Next, a structure of the heater 30 according to a second exemplary embodiment will be described. The components that have a similar structure or function to those in the first exemplary embodiment are given the same reference numerals, and description thereof is omitted. A cross-sectional structure of the heater 30 according to the second exemplary embodiment is similar to that in the first exemplary embodiment and is as illustrated in FIG. 4. Specifically, the sliding surface layer 32 on the substrate 31 is provided with the heat generation members 34a to 34c, and the rear surface layer 33 on the opposite side via the substrate 31 is provided with the thermistor T1 and the conductors 36a and 36b.

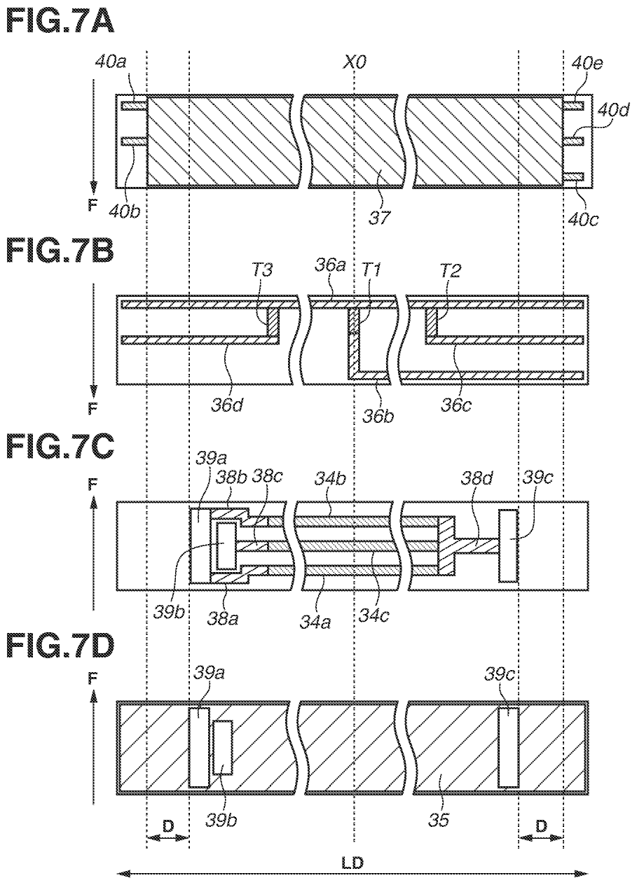

FIGS. 7A, 7B, 7C, and 7D are plan views illustrating a structure of the heater 30 according to the second exemplary embodiment. FIGS. 7A, 7B, 7C, and 7D are plan views illustrating a structure of the heater 30 in the longer-side direction. FIGS. 7A and 7B illustrate the structure viewed from the rear surface layer 33. FIG. 7A is a top view with the protection glass 37, and FIG. 7B is a top view without the protection glass 37. FIGS. 7C and 7D illustrate the structure viewed from the sliding surface layer 32. FIG. 7D is a top view with the protection glass 35. FIG. 7C is a top view without the protection glass 35.

The second exemplary embodiment is different from the first exemplary embodiment in the positions of the electrodes 39a to 39c for heat generation members and the electrodes 40a to 40e for thermistors in the longer-side direction in the heater 30. As illustrated in FIG. 7B, the rear surface layer 33 is provided with the conductor 36a which is connected to every one of thermistors T1 to T3 and extends to the respective edges of the heater 30 in the longer-side direction LD. Further, the conductors 36b to 36d are provided, and edges of the conductors 36b to 36d are respectively connected to thermistors T1 to T3 whereas the other edges of the conductors 36b to 36d extend to the edge portions of the heater 30. As illustrated in FIG. 7A, the protection glass 37 covers a portion of the conductors 36a to 36d in such a manner that the edge portions of the conductors 36a to 36d are exposed. In FIG. 7A, the exposed portions of the conductors 36a to 36d are the electrodes 40a to 40e for thermistors. The electrodes 40a and 40b for thermistors on the left hand side of FIG. 7A form the second electrode group, and the electrodes 40c to 40e for thermistors on the right hand side of FIG. 7A also form the second electrode group. The electrodes 39a to 39c for heat generation members are provided nearer to the center of the heater 30 in the longer-side direction LD than the electrodes 40a to 40e for thermistors. The electrodes 39a and 39b for heat generation members on the left hand side of FIGS. 7C and 7D form the first electrode group, and one electrode 39c for heat generation members is formed on the right hand side of FIGS. 7C and 7D. As in the first exemplary embodiment, the distance D is preserved between the electrode 39a for heat generation members and the electrodes 40a and 40b for thermistors and also between the electrode 39c for heat generation members and the electrodes 40c to 40e for thermistors, in the longer-side direction LD of the heater 30. As in the first exemplary embodiment, the distance D is a distance whereby the insulation distance is preserved between two electrodes.

In the heater 30 according to the present exemplary embodiment, the electrodes 39a to 39c for heat generation members are provided nearer to the center in the longer-side direction LD of the heater 30 than the electrodes 40a to 40e for thermistors. This structure makes it possible to reduce the distances between the electrodes 39a to 39c for heat generation members and the heat generation members 34a to 34c, so that an effect of voltage drop is minimized and higher heat generation efficiency of the heat generation members 34a to 34c than the first exemplary embodiment is realized.

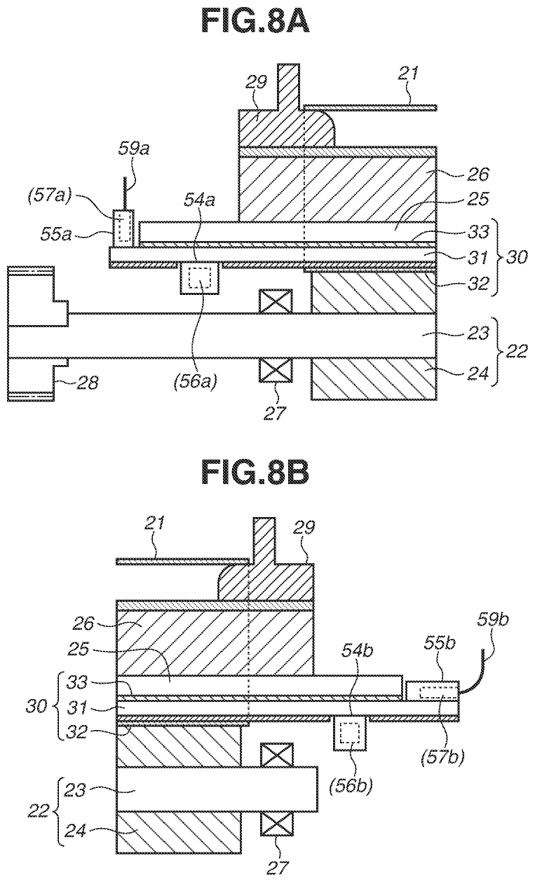

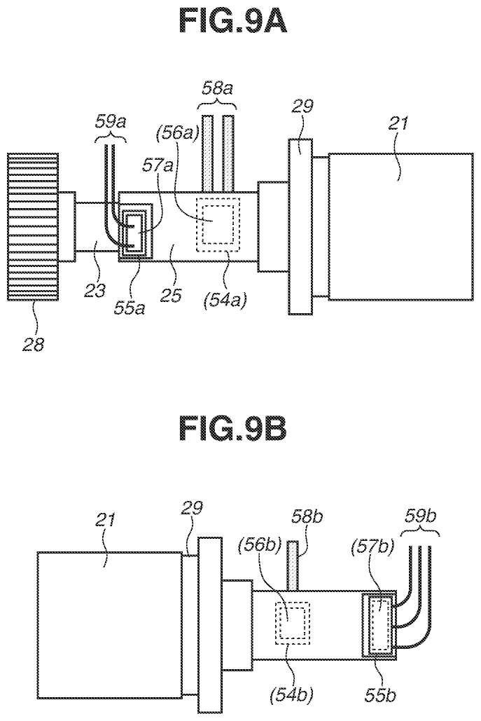

FIGS. 8A, 8B, 9A, and 9B illustrate a structure of the electric contact members and the conductive members according to the second exemplary embodiment. FIGS. 8A and 8B are cross-sectional views illustrating a structure of the edge portions of the fixing device 20 viewed from the direction of the line A-A specified in FIG. 2. FIG. 8A illustrates a structure of the driving-side edge portion, and FIG. 8B illustrates a structure of the non-driving-side edge portion. Further, FIGS. 9A and 9B are top views of FIGS. 8A and 8B. FIG. 9A illustrates the structure of the driving-side edge portion, and FIG. 9B illustrates the structure of the non-driving-side edge portion.

In the first exemplary embodiment, the U-shaped plug-in connectors are described as the electric contact members and the cables as the conductive members. In the second exemplary embodiment, connectors including combinations of male connectors to be attached to the heater 30 and cables having edges provided with female connectors are used. Male connectors54a and 54b for heat generation members are electric contact members and attached to the heater 30. Male connectors 55a and 55b for thermistors are attached to the heater 30. Female connectors (first power feeding terminal) 56a and 56b are provided to the edges of the conductive members for heat generation members, and the conductive members include cables 58a and 58b joined to the female connectors 56a and 56b by crimping or welding. The conductive members for heat generation members are connected to the male connectors 54a and 54b for heat generation members. Similarly, female connectors (second power feeding terminal) 57a and 57b are provided to the edges of the conductive members for thermistors, and the conductive members include cables 59a and 59b joined to the female connectors 57a and 57b by crimping or welding. The conductive members for thermistors are connected to the male connectors 55a and 55b for thermistors. As described above, the first electrodes 39a to 39c are provided such that the plurality of first power feeding terminals 56a and 56b is connected to the first electrodes 39a to 39c from a direction which intersects with the longer-side direction LD of the substrate 31 and which is parallel to the first surface 31a of the substrate 31. The second electrodes 40a to 40e are provided such that the plurality of second power feeding terminals 57a and 57b is connected to the second electrodes 40a to 40e from a direction which intersects with the longer-side direction LD of the substrate 31.

In the second exemplary embodiment, the electric contact members for heat generation members (the connectors 54a and 54b for heat generation members) and the conductive members (the cables 58a and 58b for heat generation members) are also provided along the shorter-side direction of the heater 30. Specifically, as in the first exemplary embodiment, the electric contact members and the conductive members are provided inside in the longer-side direction LD so as to not pass through the back of the electrodes provided outside in the longer-side direction LD. In this way, the insulation distance is preserved between the electric contact members and the conductive members and the other electrodes.

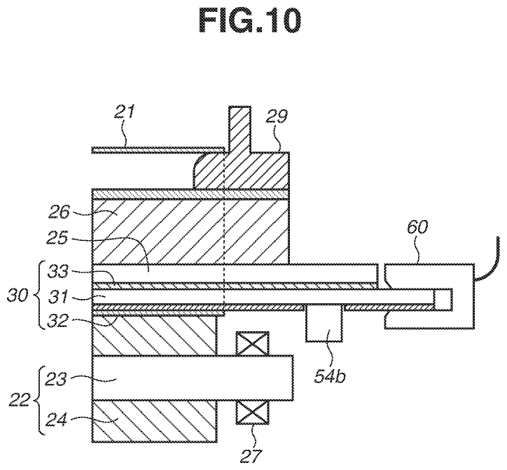

In the second exemplary embodiment, U-shaped plug-in connectors can be used as the electric contact members as in the first exemplary embodiment. FIG. 10 illustrates a structure in which a U-shaped plug-in connector 60 is provided as the electric contact member to the electrodes 40a to 40e for thermistors according to the second exemplary embodiment. The electric contact members can be configured to be insertable and removable in the longer-side direction LD as long as the electric contact members are provided outside in the longer-side direction LD as illustrated in FIG. 10. Specifically, the second electrodes 40a to 40e are provided such that the plurality of second power feeding terminals 60 is connected to the second electrodes 40a to 40e from a direction which is parallel to the longer-side direction LD of the substrate 31. While FIGS. 5A, 5B, 5C, and 5D illustrate the structure in which the electrodes 40a to 40e for thermistors according to the first exemplary embodiment are aligned in the longer-side direction, the electrodes 40a to 40e for thermistors can be aligned in the shorter-side direction of the heater 30 as long as the electrodes 40a to 40e are provided outside the heater 30 as in the second exemplary embodiment as illustrated in FIGS. 7A, 7B, 7C, and 7D. This structure has an advantage that the size of the heater 30 in the longer-side direction can be reduced compared to the first exemplary embodiment.

A heater according to a third exemplary embodiment is a heater in which a heat generation region is divided in the longer-side direction LD. The components that have a similar structure or function to those in the first and second exemplary embodiments are given the same reference numerals, and description thereof is omitted.

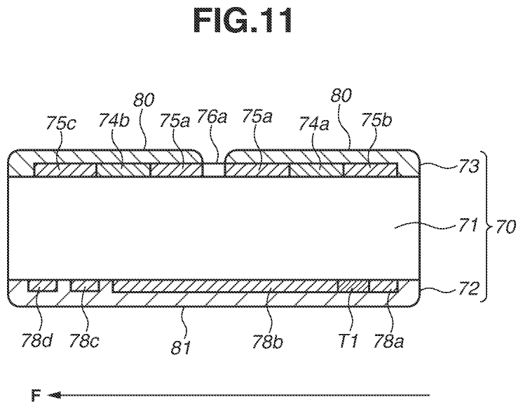

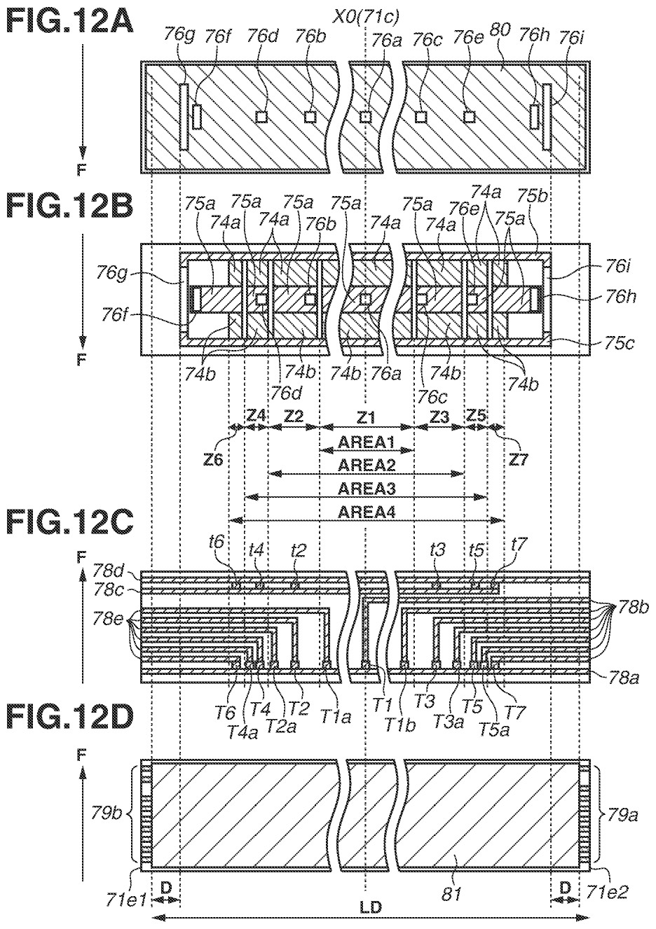

FIG. 11 is a cross-sectional view illustrating a heater 70. FIGS. 12A, 12B, 12C, and 12D are plan views illustrating a structure of the heater 70. FIG. 11 is a cross-sectional view along the sheet conveyance reference position X0 specified in FIGS. 12A, 12B, 12C, and 12D.

As illustrated in FIG. 11, the heater 70 has a layered structure including a sliding surface layer 72, a substrate 71, and a rear surface layer 73. The structure is different from those in the first and second exemplary embodiments in that the thermistor T1 and conductive members 78a to 78d for thermistors are provided to the sliding surface layer 72, and heat generation members 74a and 74b and conductive members 75a to 75c for heat generation members and an electrode 76a are provided to the rear surface layer 73. The rear surface layer 73 includes the heat generation member 74a on the upstream side and the heat generation member 74b on the downstream side in the sheet conveyance direction F of the recording material S. The conductive members 75b and 75a are provided so as to sandwich the heat generation member 74a. Similarly, the conductive members 75a and 75c are provided so as to sandwich the heat generation member 74b. If power is fed between the conductive members 75b and 75a, the heat generation member 74a generates heat. Similarly, if power is fed between the conductive members 75a and 75c, the heat generation member 74b generates heat. The electrode 76a is one of electrodes for heat generation members. The cross-sectional structure is configured in such a manner that a protection glass 80 covers the heat generation members 74a and 74b and the conductive members 75a to 75c and the electrode 76a for heat generation members is exposed.

A planar structure of each layer of the heater 70 will be described with reference to FIGS. 12A, 12B, 12C, and 12D. FIGS. 12A and 12B illustrate the structure viewed from the rear surface layer 73. FIG. 12A is a top view with the protection glass 80, and FIG. 12B is a top view without the protection glass 80. FIGS. 12C and 12D illustrate the structure viewed from the sliding surface layer 72. FIG. 12D is a top view with a protection glass 81, and FIG. 12C is a top view without the protection glass 81.

As illustrated in FIG. 12B, the rear surface layer 73 of the heater 70 is provided with seven heat generation blocks each including the conductive members 75b, 75a, and 75c, the heat generation member 74a provided on the upstream side, the heat generation member 74b provided on the downstream side, and the electrode 76 for heat generation members, in the longer-side direction. The seven heat generation blocks are denoted by Z1 to Z7 in FIG. 12B. Further, as illustrated in FIG. 12A, the protection glass 80 is formed on a portion excluding the electrodes 76a to 76i for heat generation members, and an electric contact (not illustrated) is connectable from the rear surface side of the heater 70. The control circuit 14 independently controls power supply to each heat generation block so that the amounts of heat generation of the respective heat generation blocks can be independently controlled. By division into the seven heat generation blocks as described above, at least four heat generation distributions AREA1 to AREA4 specified in FIGS. 12B and 12C are formed. In the present exemplary embodiment, AREA1 is classified as a heat generation distribution for A5-size sheets, AREA2 as a heat generation distribution for B5-size sheets, AREA3 as a heat generation distribution for A4-size sheets, and AREA4 as a heat generation distribution for LETTER sheets. The seven heat generation blocks are independently controlled so that the heat generation block that is to feed power can be selected depending on the size of the recording material S, and thus application of excess heat to the region through which no sheet passes is prevented. The length of the heat generation region and the number of heat generation blocks are not limited to those specified in the present exemplary embodiment. Further, the heat generation members 74a and 74b in each heat generation block are not limited to the continuous pattern as described in the present exemplary embodiment and can be a pattern that includes rectangles with spaces therebetween. In the present exemplary embodiment, the electrodes 76a, 76b, 76d, 76g, and 76f for heat generation members which are provided in a region from a substrate center 71c to a substrate edge portion 71e1 form the first electrode group. The electrodes 76c, 76e, 76h, and 76i for heat generation members which are provided in a region from the substrate center 71c to another substrate edge portion 71e2 form the first electrode group.

The sliding surface layer 72 of the heater 70 is provided with thermistors T1 to T7, T1a, T1b, T2a to T5a, and t2 to t7 for detecting the temperature of each heat generation block of the heater 70. The thermistors T1 to T7 are mainly used to control the temperature of each heat generation block (control to maintain a constant temperature) and are each provided at a substantially central portion of each heat generation block. Hereinafter, the thermistors T1 to T7 will be referred to as “central thermistors”.

The thermistors T1a, T1b, and T2a to T5a are thermistors for detecting the temperature of an edge portion of each heat generation block. Hereinafter, the thermistors T1a, T1b, and T2a to T5a will be referred to as “edge portion thermistors”. The edge portion thermistors are provided in the respective heat generation blocks excluding the heat generation blocks (Z6, Z7), which are respectively provided at the edges and have a small heat generation region, and each edge portion thermistor is provided nearer to an edge portion of the heat generation block than to the center of the heat generation block. No edge portion thermistor is provided in the heat generation blocks Z6 and Z7 because the heat generation regions of the heat generation blocks Z6 and Z7 are small and no edge portion thermistor needs to be provided.

The thermistors t2 to t7 are sub-thermistors provided to detect a temperature even in a case where the central thermistors or the edge portion thermistors become out of order. The sub-thermistors t2 to t7 are provide at substantially the same positions as the central thermistors T2 to T7 in the longer-side direction LD.

One edges of the central thermistors T1 to T7 and the edge portion thermistors T1a, T1b, and T2a to T5a are connected to the common conductive member 78a, and the other edges are connected to the conductive member 78b and 78e. One edges of the sub-thermistors t2 to t7 are connected to the common conductive member 78c, and the other edges are connected to the common conductive member 78d. The conductive members 78a to 78d extend to the edges of the heater 70 in the longer-side direction.

As illustrated in FIG. 12D, the protection glass 81 covers the various thermistors and the conductive members 78a to 78d in such a manner that the edge portions of the conductive members 78a to 78d are exposed. The exposed portions of the conductive members 78a to 78d become electrodes 79a and 79b for thermistors and form the second electrode group.

With the above-described heater circuit structure, the temperature of each heat generation block is independently controllable while the temperatures are detected in detail. This makes it possible to provide a fixing device capable of performing optimum control for the size of a recording material S to be conveyed. While the structure including the sub-thermistors is described in the present exemplary embodiment, the structure is not limited to the above-described structure. The sub-thermistors are included to enable more advanced and elaborate control.

The first electrodes 76a to 76i are aligned in the longer-side direction LD of the substrate 31, and the second electrodes 79a and 79b are aligned in the shorter-side direction of the substrate 31. The distance D is provided also in the present exemplary embodiment between the outermost electrodes 76i and 76g, among the electrodes 76a to 76i for heat generation members, and the electrodes 79a and 79b for thermistors, respectively. The distance D is a distance whereby an insulation distance is preserved between two electrodes, as in the first and second exemplary embodiments. Further, the first electrodes 76a to 76i for heat generation members are provided nearer to the center in the longer-side direction LD than the electrodes 79a and 79b for thermistors, as in the second exemplary embodiment.

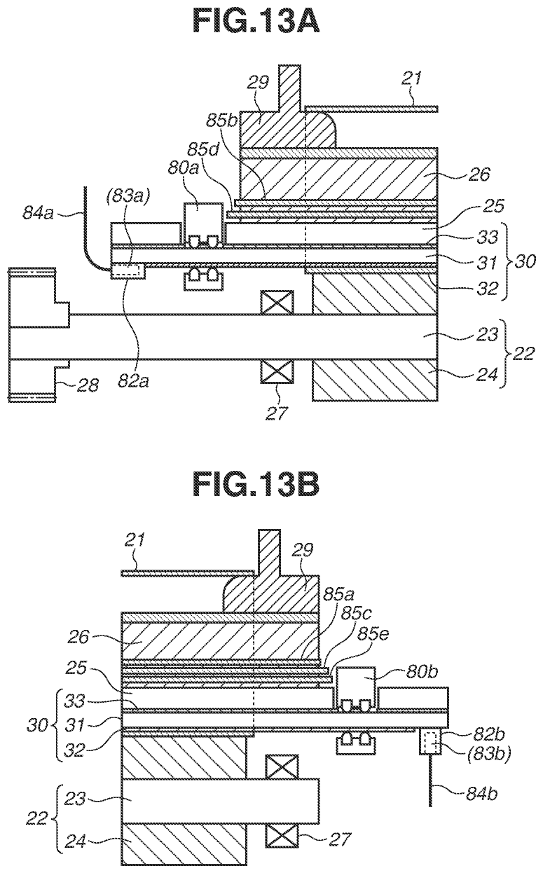

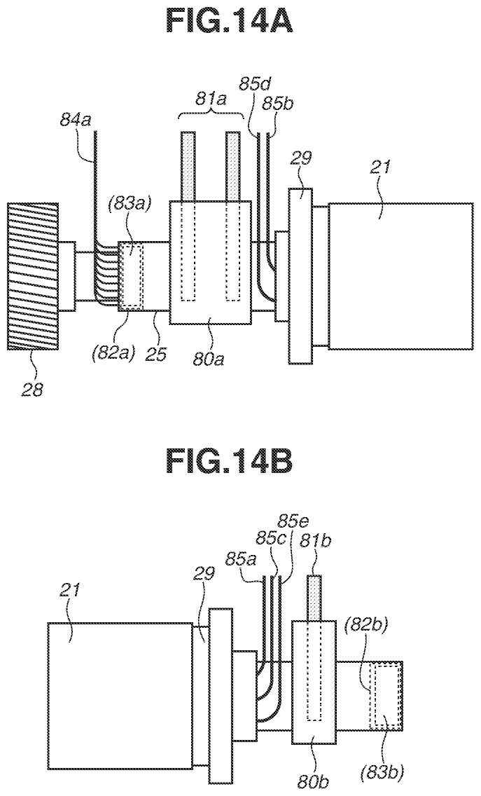

FIGS. 13A, 13B, 14A, and 14B illustrate a structure of the electric contact members and the conductive members according to the third exemplary embodiment. FIGS. 13A and 13B illustrate is a cross-sectional view viewed from the line A-A specified in FIG. 2 and illustrate a structure of each edge portion of the fixing device 20. FIG. 13A illustrates a structure of the driving-side edge portion, and FIG. 13B illustrates a structure of the non-driving-side edge portion. Further, FIGS. 14A and 14B correspond to top views of FIG. 13. FIG. 14A illustrates the structure of the driving-side edge portion, and FIG. 14B illustrates the structure of the non-driving-side edge portion.

Electric contact members 80a and 80b feed power to the electrodes 76f, 76g, 76h, and 76i for heat generation members and are connectors for heat generation members including U-shaped plug-in connectors. Cables 81a and 81b which are conductive members extend from the connectors 80a and 80b for heat generation members along a shorter-side direction of the heater 70 and are connected to the control circuit 14 through a path (not illustrated). The electrode 79a for thermistors which is on the non-driving side is provided with a male connector 82b. The male connector 82b is insertable and removable in a direction that is perpendicular to a surface of the heater 70. On the other hand, the electrode 79b for thermistors which is on the driving-side is provided with a male connector 82a. The male connector 82a is insertable and removable in the direction that is parallel to the surface of the heater 70. Cables 84a and 84b which respectively have female connectors 83a and 83b are respectively connected to the male connectors 82a and 82b. The female connectors 83a and 83b are respectively provided to an edge of the cable 84a and an edge of the cable 84b. The cables 84a and 84b of the female connectors 83a and 83b are connected to the control circuit 14.

A cable 85a is a conductive member connected to the electrode 76a for heat generation members. Similarly, cables 85b to 85e are respectively connected to the electrodes 76b to 76e for heat generation members. The cables 85a to 85e are wired along the longer-side direction LD in an inner space of the film 21. Edge portions of the cables 85b and 85d extend outward from an opening of an edge of the film 21. Edge portions of the cables 85a, 85c, and 85e extend outward from an opening of another edge of the film 21. Further, the cables 85a to 85e are wired through the inside of the connectors 80a and 80b for heat generation members toward the shorter-side direction of the heater 70.

The electric contact members (connectors 80a and 80b for heat generation members) for heat generation members and the conductive members (cables 81a and 81b for heat generation members) for heat generation members, which are provided inside in the longer-side direction LD of the heater 70, are provided along the shorter-side direction of the heater 70 also in the third exemplary embodiment. Specifically, the insulation distance is preserved between the electric contact members and the conductive members and the other electrodes while the electric contact members and the conductive members which are provided inside in the longer-side direction LD do not pass by the back of the electrodes provided outside, as in the first and second exemplary embodiments. Especially in the heater structure having a large number of divisions as described in the present exemplary embodiment, many connectors and cables are provided and congested. Thus, the structure according to the present exemplary embodiment is effective for realizing a compact layout while preserving the insulation distance.

The wiring direction of the conductive members extending from the electrode group provided inside in the longer-side direction LD of the heater according to the first to third exemplary embodiments only needs to be the shorter-side direction of the heater, and the conductive members can be wired in either one of upstream and downstream directions of the sheet conveyance direction of the recording material S. Further, while the thermistors described above in the first to third exemplary embodiments are printed thermistors, chip-type thermistors can be provided to the heater.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A heater for use in a fixing apparatus configured to fix an unfixed toner image formed on a recording material to the recording material, the heater comprising:
a substrate;
a plurality of heat generation members which is formed on a first surface of the substrate and is controllable independently of each other;
a first electrode group which is formed on the first surface and with which a plurality of first power feeding terminals configured to feed power to the plurality of heat generation members and provided to the fixing apparatus is in contact;
a plurality of temperature detection elements formed on a second surface of the substrate which is on an opposite side to the first surface; and
a second electrode group which is formed on the second surface and with which a plurality of second power feeding terminals configured to feed power to the plurality of temperature detection elements and provided to the fixing apparatus is in contact,
wherein at least an electrode of the first electrode group and at least an electrode of the second electrode group are formed in a region nearer to one edge portion of the substrate than to a center of the substrate in a longer-side direction of the substrate, and
wherein the electrode that is nearest to the second electrode group in the longer-side direction among the first electrode group formed in the region nearer to the one edge portion and the second electrode group are provided with a space between the electrode and the second electrode group.
